(19) United States
(12) Patent Application Publication
(10) Pub. No.: US 2021/0079535 A1
(43) Pub. Date: Mar. 18, 2021

(54) A METHOD FOR GENERATING SYNGAS FOR USE IN HYDROFORMYLATION PLANTS

(71) Applicant: HALDOR TOPSØE A/S, Kgs. Lyngby (DK)

(72) Inventors: Niels Christian SCHJØDT, Hvalsø (DK); Berit HINNEMANN, Stenløse (DK); Rainer KÜNGAS, Copenhagen S (DK); Bengt Peter Gustav BLENNOW, Humlebæk (DK)

(73) Assignee: HALDOR TOPSØE A/S, Kgs. Lyngby (DK)

(21) Appl. No.: 16/612,130

(22) PCT Filed: Apr. 16, 2018
(86) PCT No.: PCT/EP2018/059657

§ 371 Date: Nov. 8, 2019

(30) Foreign Application Priority Data
May 11, 2017 (DK) PA 2017 00298
Jul. 18, 2017 (DK) PA 2017 00418

(51) Int. Cl. C25B 1/04; C25B 9/08; B01D 53/047; C01B 3/58

(52) U.S. Cl. CPC C25B 1/04; C25B 9/08; B01D 53/047; C01B 3/58; B01D 2257/504; C01B 2203/0435; B01D 2256/20; B01D 2259/402; C01B 2203/06; C01B 2203/0475; C01B 2203/042; B01D 2256/16

(57) ABSTRACT

A method for the generation of syngas for use in hydroformylation plants comprises the steps of evaporating water to steam, mixing the steam with carbon dioxide in any desired molar ratio and feeding the resulting gas to a solid oxide electrolysis cell (SOEC) or an SOEC stack at around 700° C. while supplying an electrical current to the cell or cell stack to convert the feed gas to syngas. An advantage is that the syngas can be generated on the site where it is intended to be used.

The present invention relates to a method for generating synthesis gas (syngas) for use in hydroformylation plants.

Hydroformylation, also known as “oxo synthesis” or “oxo process”, is an industrial process for the production of aldehydes from alkenes. More specifically, the hydroformylation reaction is the addition of carbon monoxide (CO) and hydrogen (H₂) to an alkene. This chemical reaction entails the net addition of a formyl group (CHO) and a hydrogen atom to a carbon-carbon double bond. The reaction yields an aldehyde with a carbon chain one unit longer than the parent alkene. If the aldehyde is the desired product, then the syngas should have a composition close to CO:H₂₌1.1.

In some cases, the alcohol corresponding to the aldehyde is the desired product. When this is the case, more hydrogen is consumed to reduce the intermediate aldehyde to an alcohol, and therefore the syngas should have a composition of approximately CO:H₂=1:2.

Sometimes it is desired to purify the intermediate aldehyde before converting it into an alcohol. Accordingly, in such case, a syngas with the composition CO:H₂₌1:1 must first be used, followed by pure H₂.

Thus, the need for low-module syngas (i.e. low hydrogen-to-carbon monoxide ratio) is characteristic for the hydroformylation reaction. Such a syngas composition is rather costly to provide since it cannot be obtained directly from steam reforming of natural gas or naphtha. At least a steam reformed gas must undergo reverse shift, i.e. the reaction CO₂+H₂->CO+H₂O, to provide sufficient CO. Otherwise, a cold box for condensing CO has to be installed to separate the CO. This is also a costly solution, and there will be an excess of hydrogen for which a use purpose has to be found.

Alternatively, gasification plants may provide low-module syngas, but gasification plants need to be very large to be efficient, and they are expensive, both with respect to CAPEX and to OPEX. Furthermore, coal-based gasification plants are increasingly undesired due to the substantial environmental implications and a large CO₂ footprint.

Low-module (i.e. CO-rich) syngas for hydroformylation is therefore generally costly. Large hydroformylation plants are often placed in industrial areas and may thus obtain the necessary syngas “over the fence” from a nearby syngas producer. In many cases, however, this is not possible for medium or small size hydroformylation plants. Instead, such smaller plants will need to import the syngas, e.g. in gas cylinders, which is very expensive. Furthermore, transportation and handling of such gas containers is connected with certain elements of risk since syngas (not least low-module syngas) is highly toxic and extremely flammable, and syngas may form explosive mixtures with air. Import of CO by tube trailers will face similar challenges, both in terms of costs and in terms of safety.

Regarding prior art, U.S. Pat. No. 8,568,581 discloses a hydroformylation process using a traditional electrochemical cell, not a solid oxide electrolysis cell (SOEC) or an SOEC stack, for preparation of the synthesis gas to be used in the process. Water is introduced in a first (anode) compartment of the cell, and CO₂ is introduced into the second (cathode) compartment of the cell followed by alkene and catalyst addition to the cell, and the cathode induces liquid phase hydroformylation when an electrical potential is applied between the anode and the cathode.

In WO 2017/014635, a method for electrochemically reducing carbon dioxide is described. The method involves the conversion of CO₂ into one or more platform molecules such as syngas, alkenes, alcohols (including diols), aldehydes, ketones and carboxylic acids, and also conversion of CO₂ into i.a. CO, hydrogen and syngas. The method does not, however, include preparation of low-module syngas for hydroformylation.

US 2014/0291162 discloses a multi-step method for preparation of various compounds, such as aldehydes, by electrolysis of previously prepared CO₂ and/or CO and steam. The method includes i.a. heat transfer from a heating means towards a proton-conductive electrolyser comprising a proton-conducting membrane arranged between the anode and the cathode.

Finally, US 2011/0253550 discloses a method for producing a synthetic material, where water is converted into H₂ and O₂ using high-temperature electrolysis. Depending on how the catalytic process is carried out, the mixture of water vapour, CO₂ and H₂ can additionally be converted catalytically into functionalized hydrocarbons, such as aldehydes. This publication is very unspecific and does not define the concept of high-temperature electrolysis, neither in terms of temperature range nor in terms of the kind(s) of equipment being usable for the purpose.

Now it has turned out that the above-described elements of risk in relation to syngas can effectively be counteracted by generating the syngas, which is necessary for hydroformylation plants, in an apparatus based on solid oxide electrolysis cells (SOECs) or SOEC stacks. A solid oxide electrolysis cell is a solid oxide fuel cell (SOFC) run in reverse mode, which uses a solid oxide electrolyte to produce e.g. oxygen and hydrogen gas by electrolysis of water. Importantly, it can also be used for converting CO₂ electrochemically into the toxic, but for many reasons attractive CO directly at the site where the CO is to be used, which is an absolute advantage. The turn-on/turn-off of the apparatus is very swift, which is a further advantage.

So it is the intention of the present invention to provide an apparatus generating syngas based on solid oxide electrolysis cells, which can generate syngas for hydroformylation plants. The raw materials for generating the syngas will be mixtures of CO₂ and H₂O.

A solid oxide electrolysis cell system comprises an SOEC core wherein the SOEC stack is housed together with inlets and outlets for process gases. The feed gas or “fuel gas” is led to the cathode part of the stack, from where the product gas from the electrolysis is taken out. The anode part of the stack is also called the oxygen side, because oxygen is produced on this side. In the stack, CO and H₂ are produced from a mixture of CO₂ and water, which is led to the fuel side of the stack with an applied current and excess oxygen is transported to the oxygen side of the stack, optionally using air or nitrogen to flush the oxygen side. The product stream from the SOEC, containing CO and H₂ mixed with CO₂, is normally subjected to a separation process.

More specifically, the principle of producing CO and H₂ by using a solid oxide electrolysis cell system consists in leading CO₂ and H₂O to the fuel side of an SOEC with an applied current to convert CO₂ to CO and H₂O to H₂ and transport the oxygen surplus to the oxygen side of the SOEC. Air, nitrogen or carbon dioxide may be used to flush the oxygen side. Flushing the oxygen side of the SOEC has two advantages, more specifically (1) reducing the oxygen concentration and related corrosive effects and (2) providing means for feeding energy into the SOEC, operating it endothermic. The product stream from the SOEC contains a mixture of CO, H₂, H₂O and CO₂, which—after removal of water, e.g. by condensation—can be led to a separation process such as pressure swing adsorption (PSA), temperature swing adsorption (TSA), membrane separation, cryogenic separation or liquid scrubber technology, such as wash with N-methyl-diethanolamine (MDEA). PSA is especially suitable for the production of high purity syngas.

The overall principle in the production of CO by electrolysis is that CO₂ (possibly including some CO) is fed to the cathode. As current is applied to the stack, CO₂ is converted to CO to provide an output stream with a high concentration of CO:

2CO₂(anode)->2CO(cathode)+O₂(anode)

H₂O(anode)->H₂(cathode)+O₂(anode)

If pure CO₂ is fed into the SOEC stack, the output will be CO (converted from CO₂) and unconverted CO₂. If needed, the unconverted CO₂ can be removed in a CO/CO₂ separator to produce high-purity CO.

If a mixture of CO₂ and H₂O is fed into the SOEC stack, the output will be a mixture of CO, CO₂, H₂O, and H₂. In addition to the electrochemical conversion reaction of CO₂ to CO (1) given above, steam will be electrochemically converted into gaseous hydrogen according to the following reaction:

H₂O(cathode)->H₂(cathode)+O₂(anode) (2)

Additionally, a non-electrochemical process, namely the reverse water gas shift (RWGS) reaction takes place within the pores of the cathode:

H₂(cathode)+CO₂(cathode)<-><->H₂O (cathode)+CO(cathode) (3)

In state-of-the-art SOEC stacks, where the cathode comprises Ni metal (typically a cermet of Ni and stabilized zirconia), the overpotential for reaction (1) is typically significantly higher than for reaction (2). Furthermore, since Ni is a good catalyst for RWGS reaction, reaction (3) occurs almost instantaneously at SOEC operating temperatures. In other words, the vast majority of the electrolysis current is used for converting H₂O into H₂ (reaction 2), and the produced H₂ rapidly reacts with CO₂ (according to reaction 3) to provide a mixture of CO, CO₂, H₂O, and H₂. Under typical SOEC operating conditions, only a very small amount of CO is produced directly via electrochemical conversion of CO₂ into CO (reaction 1).

In case pure H₂O is fed into the SOEC stack, the conversion X_{H2O} of H₂O to H₂ is given by Faraday's law of electrolysis:

$${X}_{{H}_{2} O} = \frac{{p}_{{H}_{2}}}{{p}_{{H}_{2}} + {p}_{{H}_{2} O}} = \frac{i \cdot {V}_{m} \cdot {n}_{cells}}{z \cdot {f}_{{H}_{2} O} \cdot F} \qquad ( 4 )$$

where p_{H2} is the partial pressure of H₂ at cathode outlet, p_{H2O} is the partial pressure of steam at cathode outlet, i is the electrolysis current, Vₘ is the molar volume of gas at standard temperature and pressure, n_{cells} is the number of cells in an SOEC stack, z is the number of electrons transferred in the electrochemical reaction, f_{H2O} is the flow of gaseous steam into the stack (at standard temperature and pressure), and F is Faraday's constant.

In case pure CO₂ is fed into the SOEC stack, the conversion X_{CO2} of CO₂ to CO is given by an analogous expression:

$${X}_{{CO}_{2}} = \frac{{p}_{CO}}{{p}_{CO} + {p}_{{CO}_{2}}} = \frac{i \cdot {V}_{m} \cdot {n}_{cells}}{z \cdot {f}_{{CO}_{2}} \cdot F} \qquad ( 5 )$$

where p_{CO} is the partial pressure of CO at cathode outlet, p_{CO2} is the partial pressure of steam at cathode outlet, i is the electrolysis current, Vₘ is the molar volume of gas at standard temperature and pressure, n_{cells} is the number of cells in an SOEC stack, z is the number of electrons transferred in the electrochemical reaction, f_{CO2} is the flow of gaseous steam into the stack (at standard temperature and pressure), and F is Faraday's constant.

In case steam and CO₂ are both fed into the SOEC stack, the gas composition exiting the stack will further be affected by the RWGS reaction (3). The equilibrium constant for RWGS reaction, K_{RWGS}, is given by:

$${K}_{R W G S} = \frac{{p}_{CO} \cdot {p}_{{H}_{2} O}}{{p}_{{CO}_{2}} \cdot {p}_{{H}_{2}}} = exp ( - \frac{Δ G}{R T} ) \qquad ( 6 )$$

where ΔG is the Gibbs free energy of the reaction at SOEC operating temperature, R is the universal gas constant, and T is absolute temperature.

The equilibrium constant and therefore the extent to which electrochemically produced H₂ is used to convert CO₂ into CO, is temperature-dependent. For example, at 500° C., K_{RWGS}=0.195. At 600° C., K_{RWGS}=0.374. At 700° C., K_{RWGS}=0.619.

Thus, the present invention relates to a method for the generation of syngas for use in hydroformylation plants, comprising the steps of:
evaporating water to steam,
mixing the steam with carbon dioxide in the desired molar ratio, and
feeding the resulting gas to a solid oxide electrolysis cell (SOEC) or an SOEC stack at a sufficient temperature for the cell or cell stack to operate while supplying an electrical current to the cell or cell stack to effect the conversion of the feed gas to syngas, either fully or in part.

In the method of the invention, steam is electrochemically converted to hydrogen in an SOEC or an SOEC stack, and part of the hydrogen formed is allowed to react with carbon dioxide to form carbon monoxide and steam via the reverse water gas shift (RWGS) reaction, thus resulting in a mixture of hydrogen, steam, carbon monoxide and carbon dioxide.

The molar ratio between steam and carbon dioxide is preferably around 1:1, more preferably around 2:3 and most preferably around 0.41:0.59, since this ratio, at an operation temperature of 700° C. and a current of 50 A, will provide a syngas with the preferred CO:H₂ ratio around 1:1 as it is explained in Example 4 below.

The temperature, at which CO is produced by electrolysis of CO₂ in the SOEC or SOEC stack, is in the range from 650 to 800° C., preferably around 700° C.

The ratio between carbon monoxide and hydrogen in the gas mixture is in the range from 0.85:1.15 to 1.15:0.85, preferably from 0.90:1.10 to 1:10:0.90 and most preferably from 0.95:1.05 to 1.05:0.95, especially close to 1:1.

The product stream from the SOEC stack is subjected to a separation process in a separation unit to remove unconverted carbon dioxide from the syngas product. This separation unit is preferably a pressure swing adsorption (PSA) unit comprising an adsorption step consisting of two or more adsorption columns, each containing adsorbents which have selective adsorption properties towards carbon dioxide.

One of the great advantages of the method of the present invention is that the syngas can be generated with the use of virtually any desired CO/H₂ ratio, since this is simply a matter of adjusting the CO₂/H₂O ratio of the feed gas.

Another great advantage of the invention is, as already mentioned, that the syngas can be generated “on-site”, i.e. exactly where it is intended to be used, instead of having to transport the toxic and highly flammable syngas from the preparation site to the site of use.

Yet another advantage of the present invention is that if it is desired to switch between a CO:H₂=1:1 syngas and pure H₂, this can be done using the same apparatus, simply by adjusting the feed from 1:1 CO₂/H₂O to pure H₂O.

A still further advantage of the present invention is that syngas of high purity can be produced without in any way being more expensive than normal syngas, even though this desired high purity would prima facie be expected to entail increasing production costs. This is because the purity of the syngas is largely determined by the purity of the CO₂/H₂O feed, and provided that a feed consisting of food grade or beverage grade CO₂ and ion-exchanged water is chosen, very pure syngas can be produced.

The invention is illustrated further in the examples which follow.

### EXAMPLE 1

### CO₂ Electrolysis

An SOEC stack consisting of 75 cells is operated at an average temperature of 700° C. with pure CO₂ fed to the cathode at a flow rate of 100 Nl/min, while applying an electrolysis current of 50 A. Based on the above equation (5), the conversion of CO₂ under such conditions is 26%, i.e. the gas exiting the cathode side of the stack consists of 26% CO and 74% CO₂.

### EXAMPLE 2

### H₂O Electrolysis

An SOEC stack consisting of 75 cells is operated at an average temperature of 700° C. with pure steam fed to the cathode at a flow rate of 100 Nl/min (corresponding to a liquid water flow rate of approximately 80 g/min), while applying an electrolysis current of 50 A. Based on the above equation (4), the conversion of H₂O under such conditions is 26%, i.e. the gas exiting the cathode side of the stack consists of 26% H₂ and 74% H₂O.

### EXAMPLE 3

### Co-Electrolysis

An SOEC stack consisting of 75 cells is operated at an average temperature of 700° C. with a mixture of steam and CO₂ in a molar ratio of 1:1 being fed to the cathode with a total flow rate of 100 Nl/min, while applying an electrolysis current of 50 A. In the stack, steam is electrochemically converted into H₂ according to reaction (2). Assuming that any electrochemical conversion of CO₂ via reaction (1) is negligible, 52% of the fed steam is electrochemically converted into hydrogen. Were the RWGS reaction not present, the gas exiting the stack would have the following composition: 0% CO, 50% CO₂, 26% H₂ and 24% H₂O. However, due to the RWGS reaction, some of the produced hydrogen will be used to generate CO. Therefore, the gas exiting the stack will actually have the following composition: 10.7% CO, 39.3% CO₂, 15.3% H₂, and 34.7% H₂O. The ratio of CO:H₂ in the product gas is thus 1:1.43.

### EXAMPLE 4

### Co-Electrolysis

An SOEC stack consisting of 75 cells is operated at an average temperature of 700° C. with a mixture of steam and CO₂ being fed to the cathode in a molar ratio of 41:59 with a total flow rate of 100 Nl/min, while applying an electrolysis current of 50 A. In the stack, steam is electrochemically converted into H₂ according to reaction (2). Assuming that any electrochemical conversion of CO₂ via reaction (1) is negligible, 64% of the fed steam is electrochemically converted into hydrogen. Were the RWGS reaction not present, the gas exiting the stack would have the following composition: 0% CO, 59% CO₂, 26% H₂ and 15% H₂O. However, due to the RWGS reaction, some of the produced hydrogen will be used to generate CO. Therefore, the gas exiting the stack will actually have the following composition: 13.2% CO, 45.8% CO₂, 13.0% H₂, and 28.0% H₂O. The ratio of CO:H₂ in the product gas is thus 1:1.01.

1. A method for the generation of syngas for use in hydroformylation plants, comprising the steps of:
evaporating water to steam,
mixing the steam with carbon dioxide in the desired molar ratio, and
feeding the resulting gas to a solid oxide electrolysis cell (SOEC) or an SOEC stack at a sufficient temperature for the cell or cell stack to operate while supplying an electrical current to the cell or cell stack to effect the conversion of the feed gas to syngas, either fully or in part.

2. The method according to claim 1, wherein steam is electrochemically converted to hydrogen in an SOEC or an SOEC stack, and part of the hydrogen formed is allowed to react with carbon dioxide to form carbon monoxide and steam via the reverse water gas shift (RWGS) reaction, thus resulting in a mixture of hydrogen, steam, carbon monoxide and carbon dioxide.

3. The method according to claim 1, wherein the operating temperature is in the range from 650 to 800° C.

4. The method according to claim 3, wherein the operating temperature is around 700° C.

5. The method according to claim 1, wherein the electrolysis current is in the range from 1 to 100 A.

6. The method according to claim 1, wherein the ratio between carbon monoxide and hydrogen in the gas mixture is in the range from 0.85:1.15 to 1.15:0.85.

7. The method according to claim 1, wherein the product stream from the SOEC stack is subjected to a separation process in a separation unit to remove unconverted carbon dioxide from the syngas product.

8. The method according to claim 7, wherein the separation unit is a pressure swing adsorption (PSA) unit comprising an adsorption step consisting of two or more adsorption columns, each containing adsorbents with selective adsorption properties towards carbon dioxide.
